(19) United States
(12) Patent Application Publication
(10) Pub. No.: US 2004/0051208 A1
(43) Pub. Date: Mar. 18, 2004

(54) Process for forming foil

(76) Inventor: Sara Creekmore, Magdalena, NM (US)

Correspondence Address: LAW OFFICE OF RAY R. REGAN, Ray R. Regan, Esq., P.O. Box 1442, Corrales, NM, 87048, US

(21) Appl. No.: 10/245,448

(22) Filed: Sep. 17, 2002

(51) Int. Cl. B05D 3/02

(52) U.S. Cl. 264/299; 427/376.1

(57) ABSTRACT

A process for forming foil. A carrier is provided in a solution comprising water with approximately 3% methyl ethyl cellulose. A pigment consisting of a dispersion of mica flakes is mixed with the carrier to provide a mixture. The mixture is applied to a surface to dry. The mixture may be poured or sprayed on the surface and allowed to dry. When dry, the mixture is removed from the surface as a sheet of foil that is malleable and consistent in color.

### FIELD OF THE INVENTION

The present invention pertains generally to forming decorative sheeting. More particularly, the new and useful invention claimed in this document pertains to a process for forming foil. The present invention is particularly, but not exclusively, useful for making sheets of colored foil having surfaces of varying texture that may be used either separately or incorporated into arts and crafts.

### BACKGROUND OF THE INVENTION

Hobbies, arts and crafts constitute a multi-billion dollar international industry. Crafts and hobbies include at least needlecraft, embroidery, knitting, crocheting, needlepoint, home decor, quilting and similar crafts; painting and finishing, which may include art, drawing, decorative painting, fashion fabric painting, home decor painting, stenciling and similar procedures; floral crafts, such as floral arrangements and similar efforts; and the broad category of general crafts, which may include beading, ceramics, glass crafting, picture framing, jewelry manufacturer, leather crafts, macrame, wall decor, paper crafts, woodworking, weaving, and other works (collectively, “arts and crafts”). The collective value of the arts and crafts industry in the United States grew to $25.7 billion in 2001, an increase of 11% compared to $25 billion in the year 2000. In the United States, 76% of all U.S. households reported at least one family member has participated in arts and crafts. The number of participants (“crafters”) continues to grow exponentially. The number of crafters who created more projects each year than the year before has also increased, up to ten projects in the year 2001.

Among the classifications and categories of arts and crafts, glass is one of the most significant. Not only is glass one of the most useful materials in the world, it has long been used in the formation of art. Made chiefly from silica sand (or silicon dioxide), soda ash (or sodium carbonate), and limestone (or calcium carbonate), glass has countless uses. It is, of course, found in windows, electrical products, fiberglass textiles, containers, safety glass, a combination of glass and ceramic cookware, laboratories, optics, and as indicated, in all forms and shapes of arts and crafts products.

Glass products also are an important sub-component of the broad category known as ceramics. Ceramics are one of the more important types of engineering materials that are primarily synthetic, the other two being metals and plastics. Common ceramics include such minerals as clay, feldspar, silica and talc, which collectively are minerals called silicates. Accordingly, glass is but a sub-component of ceramics, and ceramics includes a wide variety of finished products.

Counter-intuitively, glass may be shaped in a number of configurations, by a variety of methods, including blowing, pressing, drawing and casting. After a shaping process, annealing may be used to restore strength of the glass. Glass also may be strengthened by tempering. Glass may be decorated in a wide variety of ways. Glass may be etched, commonly with hydrofluoric acid; sandblasted to provide translucent surfaces; cutting; copper-wheel engraving; and by firing colored enamels and lusters that have been applied to glass by painting, as well as by decalomania, which is a process of transferring labels, as well as by silk-screen printing processes. Various decorations are heated to varying temperatures to fuse decorative materials to or into the glass. A wide variety of artistic and useful objects are thus created. Decorating glass and other ceramics is limited only by the imagination of the crafter or artist. At least one decorative objective is to coat or embed in ceramic and glass products a material that provides the impression of gold, silver, or other colored leaf or foil. Among crafters, however, foil is highly desirable for use in connection with all materials used in creating arts and crafts, not just glass. Foil sheets having a wide range of dynamic colors, and that are color-consistent through the foil sheet, are highly prized among crafters. As used in this document, the term “color” includes black and white. However, currently available foil is inordinately expensive.

In prior approaches, various means for manufacturing foils have been used or suggested. Most methods and processes of manufacturing sheets of foil, however, employ complex relatively massive apparatus generally limited to use in industrial manufacturing plants. Such machinery involves costly, complex, multi-step processes to combine various ingredients into foil products.

Other devices suggested for the manufacture of sheets of foil include large drum structures formed with compartments that are immersed during rotation of the drum in huge vats or tanks filled with a mixture or admixture of ingredients that are deposited on conveyor belt assemblies.

In addition, complicated suction mechanisms have been proposed for removing water or other ingredients from a suspension of materials deposited on the conveyor system. Special substrates have been recommended for the belt of the conveyor system to support the suspension of materials from the tanks.

Other limitations include the difficulty of inexpensively providing large sheets of foil with dynamic, consistent colors. Presently, available foil products are provided in small amounts; large sheets are unavailable. A limited range of color or pigment is available, and few dynamic colors are offered. The colors provided are not uniform throughout a sheet of foil.

Another limitation of the prior approaches is the absence of a process for forming foil that may be implemented on a small scale with inexpensive apparatus.

Therefore, a previously unaddressed need exists in the industry for a new and useful process for forming foil that is comparatively inexpensive to manufacture, malleable, capable of holding a pigment or pigmentation to provide a range of colors to a finished ceramic product, and pliable in the sense that a sheet of the foil will bend freely or repeatedly without breaking.

### SUMMARY OF THE INVENTION

Given the conventional solutions for attempting to solve problems associated with forming foil, it would be desirable and of considerable advantage to provide a process or method for forming a foil as described in this document. The present invention provides numerous advantages in connection with forming foil.

At least one of the advantages of the present invention is that the sheets of foil produced by the present invention fill a long felt, but unsatisfied, need for the invention.

Another advantage of the foil practiced in accordance with the present invention is the unexpectedness of the results of the invention even to those skilled in the art. Until now, those skilled in the art have not perceived that combining available pigments with a carrier in accordance with the present invention would produce a colored foil.

Still another advantage of the process for forming foil as shown in this document is that the mixture need not be subjected to heat or other special conditions to form the foil. The foil may be formed at ambient temperature, under no special conditions. Although the foil of the present invention is formed without special heat requirements, the foil formed in accordance with the invention may be used in connection with the production of other products necessitating the application of heat without degrading the foil.

Another advantage of the present invention is that the foil produced in accordance with the invention is malleable, but also sufficiently pliable as to not tear or render during use.

Still another advantage of the present invention is its cost. The process of forming the foil, as well as the finished foil, is comparatively less expensive that other processes currently known.

Yet another advantage of the present invention is that a foil may be produced using a variety of pigments to produce a uniform, dynamic color throughout and across the surface of a sheet of foil.

Still another advantage of the present invention is the formation of a foil having surfaces of varying textures, thus giving a crafter or artist significant options in the appearance of a finished ceramic or other product.

Yet another advantage of the present invention is its wide application. The foil produced in accordance with this invention may be used not only on ceramic products, but also on paper, cloth and a host of other surfaces and materials.

Another advantage of the present invention is a process for forming a foil that is respectively easy to use and to practice, and which is cost effective for its intended purposes.

These and other advantages are achieved in the present invention by providing a carrier. The carrier is a solution comprised of water with approximately 3% methyl ethyl cellulose. Alternatively, a gum arabic may be used as a carrier. A pigment is mixed with the carrier to provide a mixture. Preferably, the pigment is a dispersion of mica flakes. Any color of pigment may be used. A substrate or surface is selected. The mixture is applied to the surface to dry. The surface may be made of plastic, Teflon, or other nonbonding materials. While the mixture may be poured or otherwise applied to the surface to dry as a foil, preferably the mixture is placed in an air brush and sprayed on the surface to dry (“applied mixture”). The applied mixture is allowed to dry at ambient temperatures. When dry, the dried applied mixture is peeled from the surface as a sheet of foil. The resulting foil is malleable, resistant, and consistent in color. Both sides of the foil are available for use. The foils may be used in connection with objects made from glass, ceramics, paper, cloth, and other materials, either as-is, or by application of heat or pressure.

It is thus apparent to one skilled in the art that the claimed subject matter as a whole combine to result in a number of unexpected advantages and utilities. The advantages and objects of the present invention, and features of such a process for forming foil, will become apparent to those skilled in the art when read in conjunction with the accompanying following description and appended claims.

The foregoing has outlined broadly the more important features of the invention to better understand the detailed description which follows, and to better understand the contribution of the present invention to the art. Before explaining at least one example of the process of the present invention, it is to be understood that the invention is not limited in application to the details of the example. The invention is capable of being practiced and carried out in various ways. Also, the phraseology and terminology employed in this disclosure are for purpose of description, and should not be regarded as limiting. The novel features of this invention, and the invention itself, are best understood from the accompanying specification and claims, and may be further understood with reference to the following descriptions of the invention.

### DETAILED DESCRIPTION OF THE INVENTION

The invention relates to methods for forming a foil. The steps in the processes and methods for practicing the present invention are described in the following paragraphs. As will be evident to a person skilled in the art, the described processes, methods, and examples will be useful in the production of small quantities of foil, as well as in the production of large quantities of foil.

To produce foil in accordance with the present invention, a carrier is selected. In a preferred embodiment of the present invention, the carrier is a solution of water with approximately 3% methyl ethyl cellulose, also known as an aqueous gum solution, such as that supplied by Thompson Enamels Co. and identified as KLYR-FIRE. As will be evident to a person skilled in the art, however, a variety of carriers may be used to practice the invention. The carrier selected may vary based on considerations such as the texture, aesthetics, color, strength, resiliency, malleability, and similar desired characteristics in the foil produced by the present invention. Although many carriers may be used to practice the invention, no one has considered combining the carriers discussed in this disclosure to form foil in accordance with the process of the present invention. Indeed, the use of the carriers, in combination with the pigments described below, has never been taught or suggested.

In addition, and in accordance with the invention, a pigment is mixed with the carrier to provide a mixture. A variety of pigments that may be used in practicing the invention are commercially available. Other pigments also may be developed for use with the invention. Although many pigments that may be used to practice the invention are available, no one has considered combining the pigments with a carrier to form foil in accordance with the process of the present invention. Indeed, the use of pigments in combination with a carrier as described in this document to form a foil has never been taught or suggested. For example, at least one group of pigments used by a number of crafters to produce arts and crafts having a desirable color, texture, and other qualities include what are known as “luster pigments.” Luster pigments often include mica flakes coated with a metal oxide including, but not limited to, titanium dioxide, such as titanium dioxide, ferric oxide, and similar metal oxides. However, other pigments, including other luster pigments, are commercially available. Pigments, including luster pigments, have not, however, been used in a process for making a foil as disclosed in this document.

The pigment selected for the preferred embodiment of the present invention is a dispersion of a luster pigment that includes mica flakes having a titanium dioxide coating such as supplied, for example, by Thompson's Enamels as CAREFREE LUSTERS. The luster pigments that may be used in the practice of this invention are inorganic to achieve temperature stability. However, because the foil of the present invention dries at ambient temperature, the inorganic feature of luster foils is not pertinent to practice the present invention. Luster pigments are desired by crafters, however, because the dry pigment includes particles that have been coated with at least one metal oxide layer. When applied to another material, the metal oxide particles present to a viewer the combined visual sensation of color, texture and aesthetics that is highly desired, although the particles are quite small, in the micron range. Alternatives to mica include glass. The range of metal oxides is subject only to the imagination of the artist, and have included titanium dioxide, ferric oxide, zinc oxide, zirconium oxide, nickle oxide, cobalt oxide and chromium oxide. The choice of metal oxides is often a function of the heat to which a finished material is to be kilned, but, as indicated, temperature is not a limitation of the present invention because the foil is created at ambient temperature.

Alternative pigments that may be used to practice the present invention include plate-like particles including, without limitation, sheet silicates, materials or compounds other than mica that may be coated with oxides, such as talc, caolin or other comparable minerals, bismuth oxychloride, aluminum platelets, and a wide variety of similar compounds and minerals.

As will be evident to a person skilled in the art, the use of so-called luster pigments is not a limitation on the practice of the present invention. Indeed, a wide variety of pigments that do not include the micron-sized particles having metallic oxide coatings as described in this document may be used in connection with the practice of the present invention.

The mixture is applied to a substrate having at least one surface, allowed to dry, and removed as a sheet of colored foil. While the mixture may be poured on the surface for drying, in a preferred embodiment of the present invention an air brush is used. An exemplary, but not exclusive, air brush that may be used to practice this invention is a Paasche Airbrush Set VL 3. The mixture of the carrier and pigment is placed in the air brush, and then sprayed onto a surface of a substrate to form an application. In addition, the surface preferably is nonbonding. As used in this document, the term “nonbonding” means at least that the mixture of the carrier and pigment does not stick to or adhere in the surface, but rather permits ready removal of the dried mixture from the surface. In a preferred embodiment of the present invention, the surface is plastic. The application is allowed to dry at ambient conditions. When dried, the dried sprayed mixture that forms the application is peeled from the substrate as a sheet of colored foil. The sheet of foil may be tested for durability, malleability, and appearance. Both sides of the foil are available for use. The foil is available for incorporation into objects made from glass, ceramics, paper, cloth, and other materials, either as-is, or by application of heat or pressure.

The following examples further amplify a description of the present invention:

### EXAMPLE I

This example illustrates a process for forming a foil. A carrier was selected. The selected carrier was a solution of water with approximately 3% methyl ethyl cellulose, such as supplied by Thompson Enamels Co. and identified as KLYR-FIRE. In accordance with this invention, a pigment was mixed with the carrier to provide a mixture. The pigment was a dispersion of a luster pigment that included mica flakes having a titanium dioxide coating such as supplied, for example, by Thompson's Enamels as CAREFREE LUSTERS. A substrate having a surface was selected on which to apply the mixture. The substrate was a thin sheet of plastic. An air brush was selected. An exemplary, but not exclusive, air brush that may be used to practice this invention is a Paasche Airbrush Set VL 3. The mixture was placed in the air brush, and then sprayed onto the surface of the substrate to form an application. The application was allowed to dry at ambient temperature. When dried, the dried sprayed mixture that formed the application was peeled from the substrate as a sheet of foil. The sheet of foil was tested for durability, malleability, and appearance. The resulting foil was color consistent and malleable. Both sides of the foil were available for use. The foil was available for incorporation into objects made from glass, ceramics, paper, cloth, and other materials, either as-is, or by application of heat or pressure.

### EXAMPLE II

This example illustrates a process for forming a foil without an air brush, and with a carrier selected of a gum arabic, or water-soluble gum obtained primarily from acacias such as Acadia Senegal, traditionally used in the manufacture of inks, adhesives, pharmaceuticals, and confections. A pigment also was selected. The pigment was a non-toxic, inert, mica-based powdered pearlescent pigment that for other uses than in the practice of this invention allows the pigment to be kiln fired up to 600 degrees Fahrenheit. An example of the pigment is PEARL-EX from Jacquard Products. A substrate having a surface was selected on which the mixture was poured and allowed to dry at room temperature. In this example, the surface was made of TEFLON. When dry, the poured mixture formed a sheet of foil that was removable from the TEFLON surface. The resulting foil was malleable and consistent in color.

### EXAMPLE III

This example illustrates a process for forming a foil with a carrier that was cut, or diluted. Thinning agents and alcohol were used in some examples, but in this example water was used to dilute the carrier. A carrier in a solution of water with approximately 3% methyl ethyl cellulose was used. Contrary to expectations of those skilled in the art, the use of water, rather than alcohol, caused the foil produced with the mixture of this example to dry faster than when alcohol was used, with no change in properties or quality of the resulting foil. The carrier was diluted 50% by the addition of water. Ordinary tap water was used. In accord with this example, a pigment was mixed with the carrier to provide a mixture. The pigment was a dispersion of powdered mica flakes. A substrate or surface was selected on which the mixture was applied and allowed to dry, such as a sheet of plastic. The plastic was not specially selected, and it was determined that any of numerous organic synthetic or processed materials that are mostly thermoplastic or thermosetting polymers may be used on which to apply the mixture. A spray gun was selected, the mixture placed in the spray gun, and the mixture was sprayed on the plastic. The application was allowed to dry. When dried, the resulting foil was peeled from the substrate as a sheet of foil. The resulting foil was thin, in the micron range.

While the processes for forming foil described above are examples of the present invention, and the invention has been described in detail and illustrated in the examples provided, various modifications can be made to the invention. All modifications and variations of an obvious nature are considered within the scope of the invention as claimed in the appended claims. The examples are not intended to be exclusive, and none is a limitation of the present invention. While the particular process for forming foil as disclosed in detail in this instrument is fully capable of obtaining the objects and providing the advantages stated, this disclosure is merely illustrative of the presently preferred embodiments of the invention, and no limitations are intended in connection with the details of composition other than as provided and described in the appended claims.

What is claimed is:

1. A process for forming foil, comprising:
selecting a carrier;
mixing at least one pigment with the carrier to provide a mixture;
applying the mixture to a surface;
drying the mixture to form a sheet of foil; and
separating the sheet of foil from the surface.

2. A method for forming foil as recited in claim 1, wherein the carrier selecting step includes the substep of selecting a solution of water and approximately 3% methyl ethyl cellulose.

3. A method for forming foil as recited in claim 1, wherein the carrier selecting step includes the substep of selecting an aqueous gum solution.

4. A method for forming foil as recited in claim 1, wherein the at least one pigment mixing step includes the substep of choosing a pigment to which micron sized particles have been added.

5. A method for forming foil as recited in claim 4, wherein the at least one pigment mixing step includes the substep of choosing a pigment wherein the micron sized particles are mica.

6. A method for forming foil as recited in claim 5, wherein the at least one pigment mixing step includes the substep of choosing a pigment wherein the micron sized particles are coated with a metallic oxide.

7. A method for forming foil as recited in claim 6, wherein the at least one pigment mixing step includes the substep of choosing a pigment wherein the micron sized particles are coated with titanium dioxide.

8. A method for forming foil as recited in claim 1, wherein the mixture applying step includes the substep of pouring the mixture on the surface.

9. A method for forming foil as recited in claim 1, wherein the mixture applying step includes, the substep of spraying the mixture on the surface.

10. A method for forming foil as recited in claim 1, wherein the mixture applying step includes the substep of providing a nonbonding surface.

11. A method for forming foil as recited in claim 1, wherein the mixture applying step includes the substep of selecting a plastic surface.

12. A method for forming foil as recited in claim 1, wherein the mixture applying step includes the substep of selecting a Teflon surface.

13. A method for forming foil as recited in claim 1, wherein the mixture drying step includes the substep of drying the mixture at ambient temperature.

14. A method for forming a sheet of foil, comprising:
providing one or more pigments,
wherein the one or more pigments includes the substep of choosing a pigment with at least one metal oxide coated ingredient;
selecting a carrier;
mixing the one or more pigments in the carrier to form a mixture;
providing a mixture dispenser;
placing the mixture in the mixture dispenser;
dispensing the mixture onto a substrate;
drying the mixture into a substantially cohesive sheet of foil; and
removing the substantially cohesive sheet of foil from the substrate.

15. A method for forming a sheet of foil as recited in claim 14, wherein the one or more pigments providing step includes the substep of choosing an ingredient of micron sized particles.

16. A method for forming a sheet of foil as recited in claim 15, wherein the at least one pigment mixing step includes the substep of choosing an ingredient of mica.

17. A method for forming a sheet of foil as recited in claim 16, wherein the at least one pigment mixing step includes the substep of choosing an ingredient coated with titanium dioxide.

18. A method for forming a sheet of foil as recited in claim 14, wherein the carrier selecting step includes the substep of selecting a solution of water and methyl ethyl cellulose.

19. A method for forming a sheet of foil as recited in claim 14, wherein the mixture dispenser providing step includes the substep of using a sprayer.

20. A method for forming a sheet of foil as recited in claim 14, wherein the mixture dispensing step includes the substep of spraying the mixture on the substrate.

21. A method for forming a sheet of foil as recited in claim 14, wherein the mixture dispensing step includes the substep of providing a nonbonding surface on the substrate.

22. A method for forming a sheet of foil as recited in claim 1, wherein the mixture drying step includes the substep of drying the mixture at ambient temperature.

23. A method for forming colored foil, comprising steps for:
selecting a carrier,
diluting the carrier to form a diluted carrier;
providing means for coloring the foil;
combining the diluted carrier and the means for coloring the foil into a mixture;
placing the mixture in a dispenser,
wherein the dispenser is an air brush;
choosing a substrate having a nonbonding surface;
spraying the mixture on the nonbonding surface to form a layer;
drying the layer; and
removing the layer as a sheet of colored foil.

24. A method for forming colored foil as recited in claim 23, wherein the carrier selecting step includes the substep of selecting a solution of water and approximately 3% methyl ethyl cellulose.

25. A method for forming colored foil as recited in claim 23, wherein the carrier selecting step includes the substep of selecting a gum arabic.

26. A method for forming colored foil as recited in claim 23, wherein the diluting step includes the substep of adding water to the carrier to form a 1:1 ratio of the carrier and water.

27. A method for forming colored foil as recited in claim 23, wherein the diluting step includes the substep of adding an alcohol to the carrier to form a 1:1 ratio of the carrier and alcohol.

28. A method for forming colored foil as recited in claim 23, wherein the coloring means providing step includes the substep of providing a pigment soluble in water and alcohol.

29. A method for forming colored foil as recited in claim 23, wherein the substrate choosing step includes the substep of selecting a substrate made from material selected from the group of materials consisting of plastic, metal, resin, and Teflon coated materials.
